(19) United States
(12) Patent Application Publication
(10) Pub. No.: US 2022/0051568 A1
(43) Pub. Date: Feb. 17, 2022

(54) DEMAND-BASED CONTROL SCHEMES FOR AUTONOMOUS VEHICLE SYSTEM

(71) Applicant: Glydways, Inc., South San Francisco, CA (US)

(72) Inventor: Patrick Kessler, South San Francisco, CA (US)

(21) Appl. No.: 17/398,945

(22) Filed: Aug. 10, 2021

Related U.S. Application Data
(60) Provisional application No. 63/064,317, filed on Aug. 11, 2020.

(51) Int. Cl. G08G 1/00; G06Q 10/06; G06Q 10/02; B60W 60/00; B60L 58/13; G06Q 50/30

(52) U.S. Cl. CPC G08G 1/202; G06Q 10/06315; G06Q 50/30; B60W 60/00253; B60L 58/13; G06Q 10/02

(57) ABSTRACT

A method of assigning a vehicle to a trip request in a transportation system including a plurality of vehicles configured to autonomously navigate along a roadway may include receiving, at a dispatch server system of the transportation system, a trip request. The trip request may include an origin location, a destination location, and a requested vehicle arrival time. The method may further include identifying a subset of vehicles from the plurality of vehicles, each respective vehicle in the identified subset of vehicles having sufficient energy to travel from the origin location to the destination location and having a respective estimated time of arrival at the origin location corresponding to a time at which the origin location is predicted to have available boarding capacity. The method may further include choosing, from the subset of vehicles, a selected vehicle having an earliest estimated time of arrival at the origin location.

### CROSS-REFERENCE TO RELATED APPLICATION

This application is a non-provisional of and claims the benefit under 35 U.S.C. 119(e) of U.S. Provisional Patent Application No. 63/064,317, filed Aug. 11, 2020, the contents of which are incorporated herein by reference as if fully disclosed herein.

### FIELD

The described embodiments relate generally to vehicles, and, more particularly, to schemes for controlling the operation of an autonomous vehicle system.

### BACKGROUND

Vehicles, such as cars, trucks, vans, busses, trams, and the like, are ubiquitous in modern society. Cars, trucks, and vans are frequently used for personal transportation to transport relatively small numbers of passengers, while busses, trams, and other large vehicles are frequently used for public transportation. Vehicles may also be used for package transport or other purposes. Such vehicles may be driven on roads, which may include surface roads, bridges, highways, overpasses, or other types of vehicle rights-of-way. Driverless or autonomous vehicles may relieve individuals of the need to manually operate the vehicles for their transportation needs.

### SUMMARY

A method of assigning a vehicle to a trip request in a transportation system including a plurality of vehicles configured to autonomously navigate along a roadway may include receiving, at a dispatch server system of the transportation system, a trip request. The trip request may include an origin location, a destination location, and a requested vehicle arrival time. The method may further include identifying a subset of vehicles from the plurality of vehicles, each respective vehicle in the identified subset of vehicles having sufficient energy to travel from the origin location to the destination location and having a respective estimated time of arrival at the origin location corresponding to a time at which the origin location is predicted to have available boarding capacity. The method may further include choosing, from the subset of vehicles, a selected vehicle having an earliest estimated time of arrival at the origin location, assigning the selected vehicle to the trip request, and sending information about the trip request to the selected vehicle. Each respective vehicle in the identified subset of vehicles may be, at the time the subset is identified, travelling to the origin location. Each respective estimated time of arrival of the vehicles in the identified subset of vehicles may be within a threshold time after the requested vehicle arrival time. Each respective vehicle in the identified subset of vehicles may have sufficient energy to travel from the destination location to a charging station after termination of a trip associated with the trip request.

The origin location may correspond to a first boarding zone having a first fixed location within the transportation system, and the destination location may correspond to a second boarding zone having a second fixed location within the transportation system. The trip request may be received from a mobile phone. The method may further include sending, to the mobile phone, an identifier of the selected vehicle.

A method of assigning a vehicle to a trip request in a transportation system including a plurality of vehicles configured to autonomously navigate along a roadway may include receiving, at a dispatch server system of the transportation system. The trip request may include an origin location, a destination location, and a requested vehicle arrival time. The method may further include identifying, from the plurality of vehicles, a first subset of candidate vehicles in which each vehicle is travelling to the origin location and has an estimated time of arrival at the origin location within a threshold time after the requested vehicle arrival time, identifying, from the first subset of candidate vehicles, a second subset of candidate vehicles that have sufficient energy to reach the destination location from the origin location, choosing, from the second subset of candidate vehicles, a selected vehicle having an earliest estimated time of arrival at the origin location, assigning the selected vehicle to the trip request, and sending information about the trip request to the selected vehicle. The dispatch server system may maintain a list of pending trip requests that have not been assigned a vehicle, and the trip request may be an oldest trip request in the list of pending trip requests that have not been assigned a vehicle. The threshold time may be less than or equal to ten minutes after the requested vehicle arrival time. Each respective vehicle in the second subset of vehicles may have sufficient energy to travel from the destination location to a charging station after termination of a trip associated with the trip request.

The method may further include, after assigning the selected vehicle to the trip request and prior to the selected vehicle arriving at the origin location, identifying an additional vehicle having an earlier estimated time of arrival at the origin location than the selected vehicle, cancelling the assignment of the selected vehicle to the trip request, and assigning the additional vehicle to the trip request.

A method of assigning a vehicle to a target location in a transportation system including a plurality of vehicles configured to autonomously navigate along a roadway may include, at a dispatch server system of the transportation system, identifying a vehicle to be assigned a target location, and identifying a subset of boarding zones from a plurality of boarding zones in the transportation system, each respective boarding zone in the identified subset of boarding zones having available vehicle storage capacity at an estimated time of arrival of the vehicle at the respective boarding zone, reachable by the vehicle based on the vehicle's current location and current energy state, and associated with a respective estimated vehicle demand. The method may further include choosing, from the subset of boarding zones, a selected boarding zone having a highest estimated vehicle demand, assigning the selected boarding zone as the target location of the vehicle, and sending, to the vehicle, information about the target location, thereby causing the vehicle to begin travelling to the selected boarding zone. The method may further include, after assigning the selected boarding zone as the target location of the vehicle, decrementing the estimated vehicle demand of the selected boarding zone by one vehicle. The vehicle may be parked at a charging station when it is identified.

The method may further include determining, for each respective boarding zone of the subset of boarding zones, a respective estimated vehicle demand at the estimated time of arrival of the vehicle at the respective boarding zone. The estimated vehicle demand for each respective boarding zone may be based at least in part on a historical number of trips departing from the respective boarding zone, a number of vehicles travelling to the respective boarding zone and estimated to arrive at the respective boarding zone within a particular time window, and a number of trips scheduled to depart from the respective boarding zone and for which vehicle have not been assigned. The estimated vehicle demand for each respective boarding zone may be further based at least in part on a weather forecast at the respective boarding zone. The estimated vehicle demand for each respective boarding zone may be further based at least in part on an end time of an event proximate the respective boarding zone. The particular time window may be a time prior to the estimated time of arrival of the vehicle.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts a schematic view of a transportation system.

FIG. 2 depicts an example map of the transportation system.

FIG. 3 depicts a table showing an example listing of trip requests.

FIG. 4 depicts a table showing an example data set for assigning a vehicle to a trip request.

FIG. 5 depicts a table showing an example data set for allocating vehicles to boarding zones within the transportation system.

FIG. 6 depicts a table showing an example data set for allocating parked vehicles to boarding zones within the transportation system.

FIGS. 7A-7B depict an example vehicle.

FIGS. 8A-8B depict the vehicle of FIGS. 7A-7B with its doors open.

FIG. 9 depicts a partial exploded view of an example vehicle.

FIG. 10 illustrates an electrical block diagram of an electronic device that may perform the operations described herein.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments as defined by the appended claims.

The embodiments herein are generally directed to a transportation system in which numerous vehicles may be autonomously operated to transport passengers and/or freight along a roadway. For example, a transportation system or service may provide a fleet of vehicles that operate along a roadway to pick up and drop off passengers at pre-set locations or stops, referred to herein as boarding zones (e.g., selected by a person via a smartphone). As used herein, the term “roadway” may refer to a structure that supports moving vehicles.

Operation of a transportation system is a complicated task, however, as the particular times and locations at which vehicles are requested by users may be difficult to predict. This may make it difficult to plan where to stage or store vehicles in the transportation system so that trip requests may be fulfilled quickly and without excessive wait times. For example, if all vehicles in the transportation system were to be stabled at a central parking garage when they are actively carrying a passenger, the time for a vehicle to travel to a distant boarding zone to fulfill a trip request may be unreasonably long to satisfy customer preferences. Further, even if vehicle storage facilities are distributed throughout the transportation system, under some operating conditions it may not be cost effective or space efficient to simply fill each storage facility with the maximum number of cars needed to fulfill the highest possible demand in that region of the transportation system.

Accordingly, as described herein, a centralized dispatch server system may be used to identify and/or predict the vehicle demand at various locations (e.g., boarding zones) in the transportation system, and intelligently route vehicles to the locations based on the predicted demands. The centralized dispatch server system, which may be part of or operate in conjunction with an overall transportation system controller, may be particularly well suited to identifying and/or predicting vehicle demands, as it can use known data and parameters of the entire system, including the locations of vehicles, traffic conditions, roadway conditions, the parameters of all trip requests (e.g., origin, destination, time), and the like. The centralized dispatch server system can leverage the visibility into the whole system to intelligently route vehicles to locations where they are likely to be needed at the times they are likely to be needed. The centralized dispatch server system may be referred to herein simply as a centralized dispatch system.

In addition to predicting vehicle demands and rationally allocating vehicles to particular boarding zones based on predicted demand, the centralized dispatch system may also use its access to the real-time operating parameters of the transportation system to intelligently assign particular vehicles to trip requests. In particular, while it may be a goal of the system to provide the fastest response time to a user, the fastest response time may not always provide the best overall service to users or efficiency to the system. For example, when a trip request is received, sending the nearest vehicle to the requested boarding zone may result in the fastest response time. Assigning the nearest vehicle, however, will not be adequate if that vehicle does not have sufficient energy to reach the destination boarding zone of the trip request and/or to reach a charging station after reaching the destination boarding zone. Further, assigning that vehicle may not provide a satisfactory user experience if it would ultimately deliver the passenger to the destination location at a time when the destination boarding zone is full and therefore requires the user to wait in the vehicle for a boarding position to become available.

The centralized dispatch system described herein leverages its extensive data about the historical, current, and future states of the system in order to efficiently assign vehicles to trip requests in a manner that balances speed of service with overall system efficiency. For example, when assigning vehicles to trip requests, the centralized dispatch system may use its knowledge of the charge or fuel state of each vehicle to select a vehicle that has suitable energy (e.g., battery charge, fuel stores, etc.) to complete the requested trip and also to complete a subsequent trip (e.g., returning to a charge station). The centralized dispatch system may also estimate whether a candidate vehicle would arrive at the destination boarding zone at a time when the boarding zone has capacity, and reject candidate vehicles that would not. Such estimations may be based on historical data and/or knowledge of future events, thereby providing greater flexibility and accuracy in assigning vehicles and providing a seamless experience for users. These and other functions of the transportation system are described herein.

The transportation system described herein may include or be operated with a dedicated type of vehicle (or several dedicated types of vehicles), which may be configured to independently and at least semi-autonomously operate according to particular vehicle control schemes established for particular roadway segments and/or other transportation system infrastructure. While certain aspects of vehicle operation may be fully controlled by the vehicle itself, other aspects may be controlled and/or determined by the transportation system controller. For example, vehicles may be configured to autonomously and independently manage vehicle control functions such as acceleration, braking, and steering, as well as higher-level actions such as merging into and out of traffic, entering and exiting boarding zones, dynamically forming platoons, etc. On the other hand, the transportation system controller, and more specifically a centralized dispatch system of the transportation system controller, may assign vehicles to particular destinations, for fulfilling trip requests, allocating vehicles throughout the system, or the like.

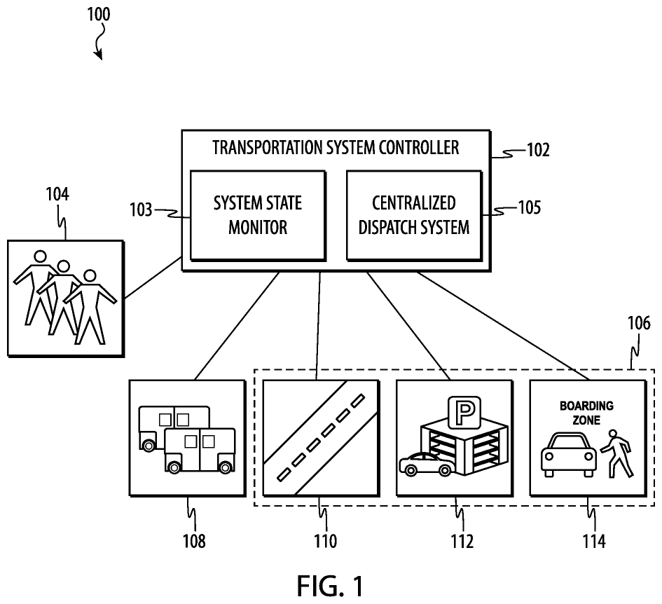

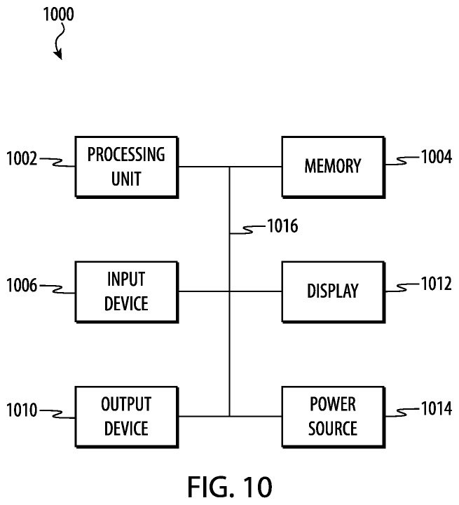

FIG. 1 illustrates an example transportation system 100 that may use the techniques described herein. The transportation system 100 includes a transportation system controller 102 that communicates with, receives information from, and/or controls operations of various components of the transportation system 100. For example, the transportation system controller 102 receives trip requests (and optionally other information) from users 104 of the system. Trip requests may include information such as the identity of the requestor, an origin location (e.g., a boarding zone or other location where the user is to be picked up), a destination location (e.g., a boarding zone or other location where the user is to be dropped off), and, optionally, a requested vehicle arrival time (e.g., a time at which the vehicle should arrive at the origin location). The requested vehicle arrival time may be specified by the user, and may correspond to a request for an immediate or as-soon-as-possible pickup, or a specified future time. In some cases, the requested vehicle arrival time may be calculated or estimated based on a user-specified destination arrival time. For example, the user may specify that they want to arrive at a boarding zone at an airport at a specified time. The user's device and/or the transportation system controller 102 may calculate the vehicle arrival time at the origin location based on factors including but not limited to the specified destination arrival time, the length of the trip, predicted or actual traffic conditions, weather conditions, and the like. Trip requests may be sent to the transportation system controller 102 via smartphones, computers, conventional telephones, wearable devices, or any other suitable device and/or communication technique. The transportation system controller 102 may include one or more electronic devices, such as computer systems, such as the electronic device 1000 described with respect to FIG. 10.

The transportation system controller 102 may include a system state monitor 103 and a centralized dispatch server system 105 (referred to herein simply as a centralized dispatch system 105), among other possible modules, programs, or other systems that facilitate the operation of various aspects of the transportation system. The system state monitor 103 and the centralized dispatch system 105 may be implemented by any suitable combination of computer hardware (e.g., processors, memory, non-transitory computer readable storage media), computer software (e.g., computer programs, applications, firmware, etc.), sensors, communication systems, etc., that facilitate the operations performed by the system state monitor 103 and/or the centralized dispatch system 105. For example, the system state monitor 103 and the centralized dispatch system 105 may be implementations of the electronic device 1000, or may be instantiated as one or more resources of the electronic device 1000. It will be understood that the delineation between the transportation system controller 102, the system state monitor 103, and the centralized dispatch system 105 are merely to aid in the description of their functionality, and do not necessarily correspond to any hardware, software, programmatic, or other distinctions. For example, in some cases the transportation system controller 102 may be implemented by a single computer system (e.g., a server) which executes a single program that performs system state monitoring functions, centralized dispatch functions, and any other transportation system functions. In other cases, the transportation system controller 102 may be implemented by various computer systems (e.g., multiple servers), with different computer systems performing different tasks, operations, or functions (e.g., transportation system state monitoring functions, dispatch functions, etc.).

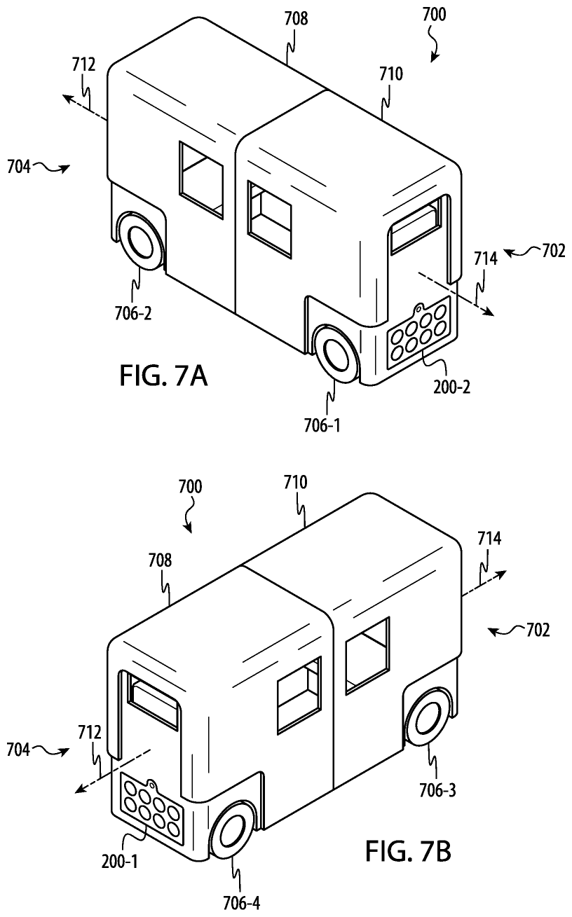

The transportation system controller 102 may receive information from, send information and/or commands to, control operations of, and/or otherwise communicate with the vehicles 108 of the transportation system 100 as well as transportation system infrastructure 106. The vehicles 108 may be a fleet of a dedicated type of vehicle that are configured to independently and at least semi-autonomously operate according to particular vehicle control schemes. An example vehicle 108 is described herein with respect to FIGS. 7A-9. In some cases, the vehicles 108 are electric vehicles, and are configured for bidirectional travel. The vehicles 108 may send information to the transportation system controller 102 and receive information and commands from the transportation system controller 102. For example, the vehicles 108 may send to the transportation system controller 102 information such as their charge state, their current location, their passenger/payload status, their current target location, their future target location, vehicle status information (e.g., current speed, acceleration, turning direction, braking status, vehicle orientation), vehicle maintenance information (e.g., time of last charge, battery health, battery age, fluid levels, tire pressure levels), or the like. The transportation system controller 102 may send to the vehicles 108 information such as information about a trip request that has been assigned to the vehicle (e.g., an origin location, a destination location, a requested vehicle arrival time, etc.), vehicle control commands (e.g., to change vehicle control parameters such as maximum speed, minimum speed, vehicle following distances, etc.), destination and/or service commands (e.g., travel to a charging station to recharge, travel to a particular parking garage or boarding zone for staging, etc.). Other types of information may be sent and/or received between the transportation system controller 102 and the vehicles 108.

The transportation system controller 102 may also receive information from, send information and/or commands to, control operations of, and/or otherwise communicate with the transportation system infrastructure 106. The transportation system infrastructure 106 may include roadways 110, parking garages 112, and boarding zones 114. Roadways 110 may include road, bridges, overpasses, elevated roadway sections, and other surfaces on which the vehicles may travel. The parking garages 112 may include parking facilities, charging and/or refueling stations, maintenance bays. Vehicles may be stored in the parking garages when they are not in use in the system for another purpose (e.g., handling a trip request, staged at a boarding zone for imminent use, etc.). The boarding zones 114 may be fixed locations and/or facilities in the transportation system 100 that are designed for the loading and unloading of passengers into and out of the vehicles. Accordingly, the boarding zones 114 may include pedestrian access infrastructure (e.g., sidewalks, stairs, etc.) as well as parking spots where the vehicles can be parked during loading and unloading of passengers. The boarding zones 114 may also include parking spots for vehicles that are in a standby or staging mode (e.g., vehicles that are not loading or unloading passengers, but instead are waiting for a trip assignment). As described herein, the boarding zones 114 may be designed for use by vehicles that are capable of bidirectional travel. Accordingly, the boarding zones 114 may be smaller and/or more compact than would be possible with conventional, unidirectional vehicles, without sacrificing any speed or efficiency in the boarding process.

The roadways 110 may define the overall map of the transportation system 100, and the boarding zones 114 and the parking garages 112 may be distributed at various locations along the roadways 110. In some cases, the boarding zones 114 are located where they will be easily accessible to users of the transportation system 100 (e.g., near buildings or locations where people want to travel to and from), while parking garages 112 may be located in more remote or less populated locations within the transportation system 100. In some cases, a single facility or location may include a boarding zone and a parking garage.

Each element of the transportation system infrastructure 106 may include sensors, computers, communications systems, human operators, and/or other hardware and software components that facilitate monitoring and operation of the transportation system infrastructure. For example, roadways 110 may include vehicle presence sensors, vehicle speed sensors, traffic sensors, cameras, traffic control output systems (e.g., lights, signs, wireless communication systems), scales, or the like. Parking garages 112 may include vehicle presence sensors, inventory data (e.g., a listing of all vehicles that are currently stored in the garage, as well as vehicle states and vehicle information), availability of charging, refueling, or other maintenance services, and the like. Boarding zones 114 may include vehicle presence sensors, traffic sensors, sensors to detect the presence and/or location of users, inventory data (e.g., a listing of all vehicles that are currently staged at the boarding zone 114), and the like. These components of the roadways 110, parking garages 112, and boarding zones 114 may communicate with the transportation system controller 102 to send and/or receive status information, data, signals, commands, and/or other information. Such communications may include wireless and/or wired communications techniques.

Using the information received from the vehicles 108, roadways 110, parking garages 112, and boarding zones 114 (and optionally other components of the transportation system), the system state monitor 103 may monitor and evaluate the state of the entire system at any time, and may record or store data about the system state in historical records. The transportation system controller 102 may use the historical records of the transportation system state to make predictions about various aspects of the transportation system. For example, the transportation system controller 102 may use historical trip data to predict future vehicle demand at certain boarding zones. The transportation system controller 102 may also use historical boarding zone throughput data to predict future throughput at the boarding zones. The transportation system controller 102 may also use historical traffic data to plan routes for vehicles to help avoid traffic congestion and maintain free-flowing traffic on the roadways 110.

The centralized dispatch system 105 may receive trip requests from the users 104 and assign vehicles 108 to the trip requests. For example, the centralized dispatch system 105 may receive a trip request that includes an origin location, a destination location, and a requested vehicle arrival time (which may be specified by the user or calculated or estimated by the system). The centralized dispatch system 105 may communicate with and/or use the information of the system state monitor 103 to identify candidate vehicles for each trip request, and ultimately assign a selected vehicle to each trip request. The vehicle may be selected based on various factors, such as its current location, its current energy level (e.g., battery charge level), the predicted boarding capacity of the origin and/or destination location, and the like. These factors may be available and/or determined from the current and/or historical data in the system state monitor 103.

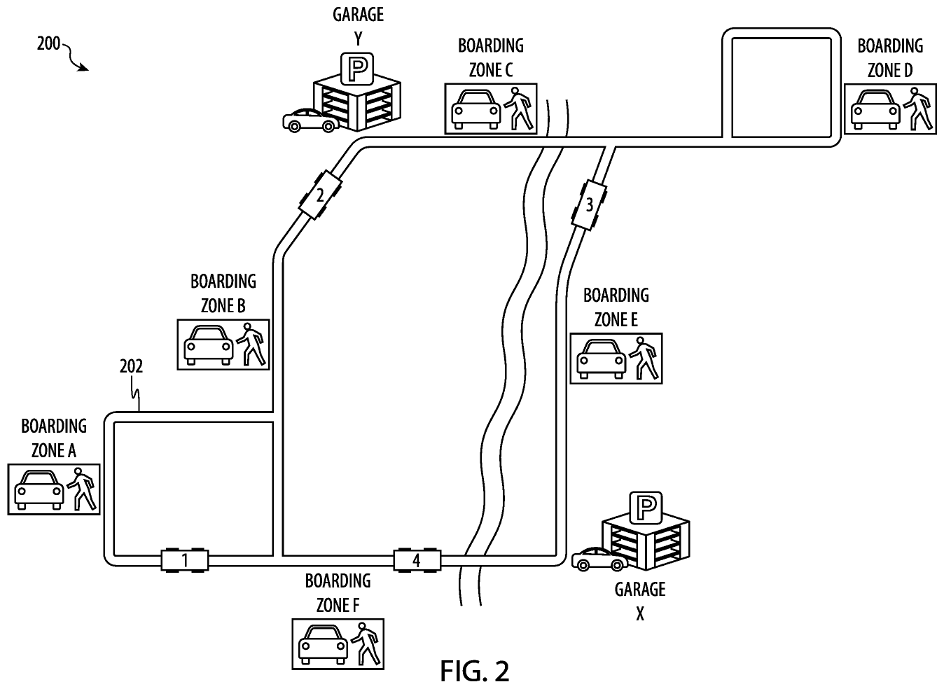

FIGS. 2-6 illustrate how the transportation system controller 102 intelligently assigns vehicles to trip requests and stages vehicles throughout the transportation system 100. FIG. 2 is an example map 200 of the transportation system 100 (or a portion thereof). The map 200 shows the locations of example vehicles (e.g., vehicles 1-4), example boarding zones (e.g., boarding zones A-F), and example parking garages (e.g., parking garages X and Y) along a roadway network 202. Of course, the map 200 is merely for illustrative purposes, and the actual numbers and locations of the vehicles, boarding zones, and parking garages will be different in different implementations of the transportation system.

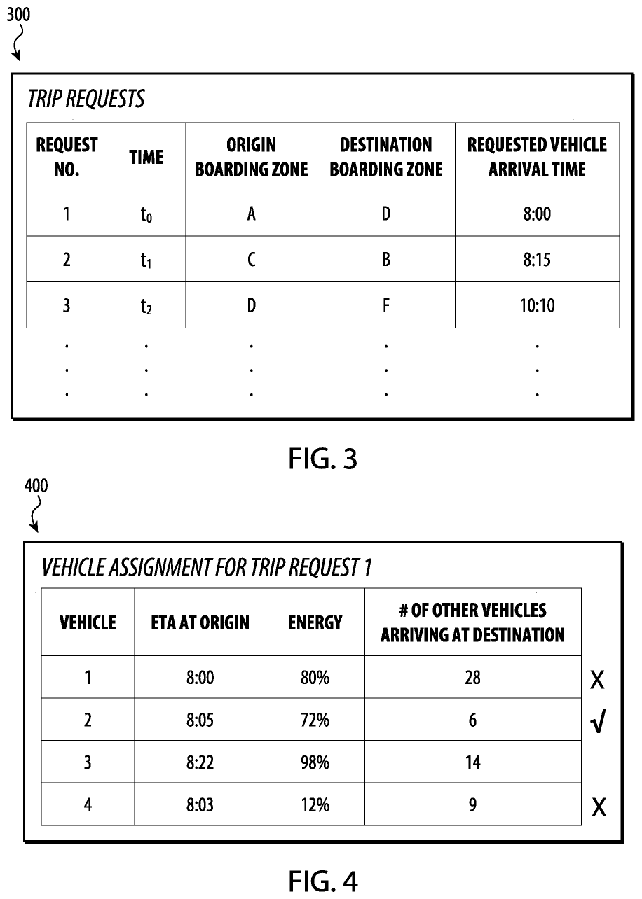

As noted above, the transportation system controller 102 may receive trip requests from the users 104 of the system. The trip requests, which may be received at the transportation system controller 102 from a mobile phone or other device associated with a user, may be included in a list of pending unpaired trip requests (e.g., trip requests that have not been assigned to a vehicle), as shown in the table 300 in FIG. 3. The table 300 includes three trip requests, and, for each trip request, includes a time the request was received (tₙ), the origin location (e.g., the origin boarding zone), the destination location (e.g., the destination boarding zone), and a requested vehicle arrival time. As noted above, the requested vehicle arrival time may be specified by a user or calculated based on other trip parameters. If the user does not specify a time or requests the trip to begin as soon as possible, the table 300 may assign an “as soon as possible” flag to that trip request and attempt to provide a vehicle as soon as possible.

In order to assign vehicles to trip requests, the centralized dispatch system 105 may choose the oldest unpaired trip in the list of unpaired trip requests (e.g., request 1 in FIG. 3) and choose a selected vehicle to assign to that trip request. Once the vehicle is chosen and assigned to a trip request, the centralized dispatch system 105 may move on to the next oldest unpaired trip request and choose a selected vehicle to assign to that trip request. The centralized dispatch system 105 may cycle through the unpaired trip request list cyclically (e.g., every five seconds, every ten seconds), or on any other suitable cycle or time frame.

In order to assign a vehicle to a trip request, the centralized dispatch system 105 may evaluate the statuses of numerous different vehicles to identify a suitable vehicle to assign to the trip. For example, the centralized dispatch system 105 may form a list of candidate vehicles by identifying a subset of vehicles in the transportation system such that each respective vehicle in the identified subset of vehicles has sufficient energy to travel from the origin location to the destination location (and optionally has sufficient energy to travel from the destination location to a charging station after termination of a trip associated with the trip request) and has a respective estimated time of arrival at the destination location corresponding to a time window in which the origin location is predicted to have available boarding capacity. In this way, the centralized dispatch system 105 can ensure that the vehicle assigned to the trip request will be able to complete the trip, and won't take the user to a destination boarding zone at a time when the boarding zone is too busy to allow the passenger(s) to disembark.

The centralized dispatch system 105 may also use other criteria to identify the subset of vehicles that may be used as candidates to fulfill a trip request. For example, the identified subset may be limited to vehicles that are, at the time the subset is identified, travelling to the origin location or at the origin location (e.g., parked and waiting for a trip assignment). This may improve overall system efficiency, as the assigned vehicle may be selected from among vehicles that are already en route to or at the origin location, rather than routing or re-routing other vehicles to the origin location which could increase traffic and congestion, and increase wait times, boarding zone delays, and the like. As another example, the identified subset may be limited to vehicles that have an estimated time of arrival at the origin location within a threshold time after the requested vehicle arrival time. Thus, the centralized dispatch system 105 will exclude from the list vehicles that are schedule to arrive at the origin location later than would be acceptable to a user. In some cases, the threshold time may be less than or equal to about 20 minutes, about 15 minutes, about 10 minutes, or about 5 minutes after the requested vehicle arrival time (or any other suitable threshold time). In some cases, if any of the criteria for identifying the subset of vehicles results in the list containing no viable candidate vehicles, that criteria may be eliminated or relaxed. For example, if there are no vehicles currently at an origin location or scheduled to arrive within the 5 minute time threshold of the requested arrival time, the centralized dispatch system 105 may increase the time threshold to 10 minutes.

Once the centralized dispatch system 105 has identified the subset of vehicles (which excludes those with insufficient energy or scheduled to arrive at the destination location when the destination is too busy), the centralized dispatch system 105 may select the vehicle, from the subset of vehicles, with the earliest estimated time of arrival at the origin location. The centralized dispatch system 105 may then send information about the vehicle to the user associated with the trip request. Such information may include, for example, an identifier of the selected vehicle, a time at which the selected vehicle will arrive at the origin boarding zone, the current location of the selected vehicle, or the like.

In some cases, after a vehicle is assigned to a particular trip, the trip may be removed from the list of unpaired trip requests (e.g., table 300, FIG. 3), and optionally included in a list of paired trip requests. The list of paired trip requests may be monitored and/or evaluated to determine if trips that are currently paired with a particular vehicle may be better served by a different vehicle (e.g., one having an earlier estimated time of arrival at the origin location than the currently assigned vehicle). If, after a vehicle is assigned to a trip, an earlier-arriving vehicle is identified for a trip, and if the currently assigned vehicle has not yet arrived at the origin location, the current vehicle assignment may be cancelled and the earlier-arriving vehicle may be assigned to the trip request instead. In such cases, the transportation system controller 102 may send a message to the user (e.g., to the user's mobile phone) allowing the user to accept or reject the reassignment.

FIG. 4 illustrates how the vehicle assignment process outlined above may proceed for trip request 1 in FIG. 3. For example, the table 400 shows various parameters for vehicles 1-4 in the transportation system illustrated in the map 200 of FIG. 2. As shown, the parameters include the estimated time of arrival of the respective vehicle at the origin location, the respective vehicle's energy state, and a number of other vehicles arriving at the destination location at the time when the respective vehicle would be arriving at that location with the passenger (which may be calculated based on the estimated time of arrival at the origin, the distance between the origin and destination locations, speed limits, weather conditions, actual or predicted traffic conditions, or the like).

The centralized dispatch system 105 may reject (e.g., purge from the list) those vehicles for which certain criteria are not met. For example, vehicle 4 has only 12% charge, and the centralized dispatch system 105 may determine that 12% charge is insufficient to allow the vehicle to complete the trip associated with trip request 1 and also return to a charging or refueling station after the trip. This determination may be based on the current location of vehicle 4, the length of the trip of trip request 1, and the distance from the destination location to a charging or refueling station (as well as other factors such as elevation changes along the trip route, traffic conditions, etc.). Accordingly, vehicle 4 may be purged from or otherwise not included in the subset of candidate vehicles from which a vehicle is to be assigned to trip request 1.

The centralized dispatch system 105 may also reject those vehicles that would arrive at a destination location when the destination location does not have sufficient capacity to allow the passenger to disembark in a timely manner. For example, the centralized dispatch system 105 may determine that boarding zone D (the destination location for trip request 1) has a boarding capacity of 15 vehicles. Accordingly, vehicle 1, which would arrive at boarding zone D within a time window when 28 other vehicles are arriving, may be purged from or otherwise not included in the subset of candidate vehicles. The time window for determining the number of other vehicles arriving at the destination zone may be about +/−1 minute from the estimated time of arrival at the destination location, +/−about 2 minutes, +/−about 3 minutes, or any other suitable time window.

The boarding capacity of a boarding zone may be different for each boarding zone, and may represent an estimate of how many boarding opportunities will be available at the boarding zone in the time window. More particularly, the boarding capacity of a boarding zone may account for the fact that each parking spot in a boarding zone may be able to accommodate multiple vehicles over the time window. Accordingly, the boarding capacity may be based at least in part on the rate at which each parking spot at the boarding zone can process vehicles (e.g., a passenger unloading/loading cycle), and the number of parking spots at the boarding zone. By evaluating the number of vehicles arriving at the destination location in a time window and by determining the boarding capacity based on the rate that the vehicles can be processed, a more useful and/or accurate estimation of the busyness of the boarding zone may be achieved, as compared to selecting a single, instantaneous time. For example, if the estimated time of arrival of vehicle 1 at the destination boarding zone is 8:00 exactly, evaluating the busyness of the boarding zone at 8:00 exactly may result in unsatisfactory results, as there could be a multitude of vehicles arriving at the destination boarding zone at 7:59, which would affect the user experience but would not be predicted if the system only considered the arrivals at 8:00.

The foregoing description relates to rejecting or purging vehicles if their estimated times of arrival at the destination locations coincides with a time when the destination locations are too busy to allow convenient unloading. In some cases, a similar evaluation may be made based on the busyness of the origin location for a trip. For example, if the estimated time of arrival of a vehicle at the origin location coincides with a time when the origin location does not have sufficient capacity (e.g., available capacity) to allow the user to board at that time, then that vehicle may be purged or otherwise excluded from the subset of candidate vehicles.

Once the subset of candidate vehicles has been created by purging or excluding vehicles that fail to satisfy certain criteria, such as those that have insufficient energy level (e.g., vehicle 4) or would arrive at the destination boarding zone at an over-capacity time (e.g., vehicle 1), the centralized dispatch system 105 may choose, from the remaining vehicles, the vehicle that has an estimated time of arrival at the origin location that is closest to the requested vehicle arrival time for the trip request (but is no earlier than the requested vehicle arrival time). Returning to FIG. 4, vehicles 1 and 4 are not in the subset of candidate vehicles (as indicted by the X mark), and so the list of candidate vehicles includes only vehicles 2 and 3. Vehicle 2 has an earlier estimated time of arrival at the origin location than vehicle 3, so the centralized dispatch system 105 chooses vehicle 2 (as indicated by the check mark in FIG. 4) and assigns vehicle 2 to trip request 1. Once the vehicle is assigned to the trip request, the centralized dispatch system 105 may move on to the next oldest trip in the system to which a vehicle has not been assigned, and perform a similar analysis to identify and assign a vehicle to that trip request.

In addition to assigning vehicles to trip requests, the centralized dispatch system 105 may perform vehicle allocation balancing processes, whereby vehicles are proactively routed to boarding zones to be staged or parked at the boarding zones to help quickly fulfil vehicle demands. As described herein, the centralized dispatch system 105 may predict the future needs of the boarding zones and send vehicles to the boarding zones based on the predicted need. Further, the centralized dispatch system 105 may continuously or cyclically monitor the state of the system, including updating predictions of vehicle demand at different boarding zones and which vehicles are located at which boarding zones, and reallocate the vehicles according to the updated system state. In this way, the centralized dispatch system 105 may respond quickly to the ever-changing vehicle demands in the transportation system to improve the efficiency and user experience by ensuring vehicles are staged near high-demand locations (wherever those locations may be).

In order to intelligently route vehicles to different boarding zones within the system, the centralized dispatch system 105 may identify vehicles in the system that have finished an assigned trip and have not yet been assigned to another trip (e.g., the process described with respect to FIG. 4 has not resulted in those vehicles being assigned to a trip request). Such vehicles may be evaluated for vehicle allocation balancing purposes, and routed to boarding zones that are in need of vehicles, or, if no suitable boarding zones are in need of vehicles, routed to a parking garage.

For each vehicle that is identified as needing to be assigned a target location, the centralized dispatch system 105 (and/or the system state monitor 103) may determine which, if any, boarding zone in the system would be most benefited by receiving that vehicle. Determining the boarding zone to assign the vehicle to may involve several considerations. For example, the centralized dispatch system 105 may first identify a subset of boarding zones (e.g., candidate boarding zones) in the transportation system that are suitable options. This may include identifying, for the subset, boarding zones that have available vehicle storage capacity (e.g., empty parking spots) at an estimated time of arrival of the vehicle at the respective boarding zone. In this way, the centralized dispatch system 105 will not send an empty vehicle to a boarding zone at a time when the boarding zone has nowhere to park or store the vehicle. The vehicle storage capacity may be determined in the same or similar manner to the boarding capacity as described above. For example, the vehicle storage capacity may be based at least in part on the rate at which each parking spot at the boarding zone can process vehicles (e.g., a passenger unloading/loading cycle), and the number of parking spots at the boarding zone. Other techniques for determining the vehicle storage capacity are also possible.

The centralized dispatch system 105 may also identify, to be included in the subset of boarding zones, those boarding zones that are reachable by the vehicle based on the vehicle's current location and current energy state. Thus, boarding zones that are too distant for the vehicle to reach based on its current location and its current energy state may be excluded from the subset of candidate boarding zones.

The centralized dispatch system 105 (and/or the system state monitor 103) may also determine estimated vehicle demands at each of the candidate boarding zones at the estimated time of arrival of the vehicle at that boarding zone. Thus, each estimated vehicle demand is specific to a particular boarding zone and is based on when the vehicle in question (e.g., the vehicle for which a boarding zone assignment is being determined) is expected to arrive at that particular boarding zone. In this way, the transportation system controller 102 can assign vehicles to boarding zones based on the expected vehicle demand when that vehicle would arrive at the boarding zone, and not simply the vehicle demand at the time the vehicle is being assigned to a boarding zone (which may be out of date by the time the vehicle actually arrives there).

The estimated vehicle demand at a boarding zone may be based on factors that help anticipate future vehicle demands. As an initial measure of vehicle demand, the centralized dispatch system 105 may determine the number of trips that have been scheduled to depart from the boarding zone over a recent time window (e.g., the last 5 minutes, 10 minutes, or the like). This may provide an average rate of departures from the boarding zone, and may represent a real-time view of the current state of demand at the boarding zone. This value may be used as general prediction of the vehicle demand at the boarding zone when the vehicle in question actually arrives. This value alone, however, does not account for other factors that may affect the vehicle demand at the time the vehicle in question actually arrives, however, so the centralized dispatch system 105 may apply other factors to better estimate the vehicle demand. For example, the estimated vehicle demand may also include the number of trip requests that have been scheduled to depart from the boarding zone around the time when the vehicle in question is estimated to arrive there, and for which vehicles have not yet been assigned.

While these values, added together, may provide a more accurate estimate of vehicle demand, they do not necessarily account for existing or predicted vehicle supply at the boarding zone. Accordingly, to ultimately determine the estimated vehicle demand at the boarding zone, the centralized dispatch system 105 may subtract the number of vehicles that are currently headed towards the boarding zone and will have the capacity to carry a passenger when they arrive at the boarding zone (e.g., will be able satisfy one of the trip requests from the boarding zone that are currently unassigned or are predicted to occur). By adding the predicted demand (e.g., a recent average historical number of trip requests) to the actual upcoming demand (e.g., actual unpaired trip requests), and subtracting the number of vehicles that are already travelling to the boarding zone and will therefore reduce the actual demand, the centralized dispatch system 105 produces a holistic view of the overall net vehicle demand for the boarding zone.

Additional factors may also be used to determine the estimated vehicle demand. For example, the centralized dispatch system 105 may use a weather forecast at the boarding zone (at the time when the vehicle in question would arrive at the boarding zone) to increase or decrease the estimated vehicle demand. In one specific example, if rain is predicted at the boarding zone when the vehicle in question would arrive, the estimated vehicle demand may be increased for that boarding zone. As another example, the centralized dispatch system 105 may use a schedule of events in the area proximate the boarding zone, and may base the estimated vehicle demand at least in part on an end time of an event. In one specific example, if a boarding zone is near a sports stadium and a game is schedule to end at a particular time, the centralized dispatch system 105 may increase the estimated vehicle demand at or around the end time of the game to account for the expected increase in vehicle demand.

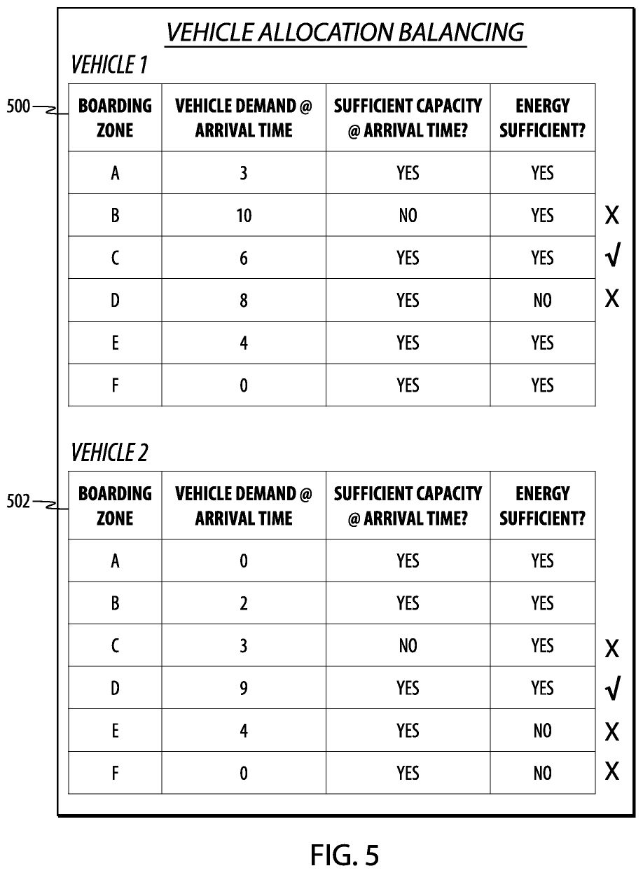

FIG. 5 illustrates how the vehicle allocation balancing process outlined above may proceed for two different vehicles. For example, table 500 shows how the boarding zones are evaluated to determine a boarding zone assignment for vehicle 1 (FIG. 2), and table 502 shows how the boarding zones are evaluated to determine a boarding zone assignment for vehicle 2 (FIG. 2). As shown, the parameters evaluated include the estimated vehicle demand at the vehicle's estimated time of arrival at that boarding zone, whether the boarding zone has sufficient vehicle storage capacity at the vehicle's estimated time of arrival, and whether the vehicle's energy is sufficient to get to that boarding zone. As described above, these and other possible factors are considered when choosing which boarding zone in the transportation system to send the vehicle to.

With reference to table 500, the centralized dispatch system 105 may identify a subset of candidate boarding zones by rejecting, purging, or otherwise not including those boarding zones for which certain criteria are not met. For example, based on the location of vehicle 1 when the evaluation process is occurring, vehicle 1 may not have sufficient energy to reach boarding zone D (e.g., based on distance, traffic conditions, energy level of the vehicle, etc.). Accordingly, boarding zone D will be excluded from the subset of candidate boarding zones (as indicated by the X). Similarly, boarding zone B may be excluded based on a determination by the centralized dispatch system 105 that it will not have sufficient vehicle storage capacity when vehicle 1 would arrive there. The estimated vehicle demand at the estimated time of arrival of vehicle 1 is also determined for each boarding zone.

With reference to table 502, the centralized dispatch system 105 may apply a similar process for the same boarding zones as shown in table 500, but with data that is specific to vehicle 2. For example, the estimated vehicle demand at the estimated time of arrival of vehicle 2 and the vehicle storage capacity at the estimated time of arrival of vehicle 2 may be determined for each boarding zone. Additionally, it is determined whether vehicle 2 has sufficient energy capacity to reach each boarding zone (e.g., based on distance, traffic conditions, energy level of the vehicle, etc.). Notably, because vehicle 1 and vehicle 2 are different distances away from each boarding zone, and have different estimated times of arrival at each boarding zone, the values of the factors are different for each vehicle. Thus, for example, boarding zones E and F may be too distant for vehicle 2 to reach based on its specific location and energy levels, and thus may be excluded from the subset of candidate boarding zones for vehicle 2. Similarly, boarding zone C may not have sufficient vehicle storage capacity at the estimated time of arrival of vehicle 2, and so it too may be excluded from the list of candidate boarding zones.

Once the list of candidate boarding zones is established (e.g., by excluding boarding zones that cannot be reached or would be too busy when the vehicle arrived), the centralized dispatch system may select, for each vehicle, the candidate boarding zone that has the highest vehicle demand. For vehicle 1, this corresponds to boarding zone C, and for vehicle 2, this correspond to boarding zone D (as indicated by the check marks). Notably, even though these assignments may take place at essentially the same time, assigning the boarding zone based on vehicle-specific factors (e.g., location, distance from boarding zone, energy levels, etc.), the process results in the vehicles being assigned to different boarding zones.

While the foregoing description of the vehicle allocation balancing process is described as applying to vehicles that are currently travelling on the roadways in the system (e.g., that are travelling to locations to drop off their passenger and have not yet been assigned to another trip), a similar process may be used by the centralized dispatch system 105 to send vehicles from parking garages to boarding zones to help balance the allocation of vehicles throughout the system. However, unlike vehicles in transit in the system, which are used for vehicle allocation balancing when they are finishing or have finished a trip and are not assigned to another trip (e.g., when they have no scheduled boarding zone target), the vehicles in the parking garage do not themselves produce any independent triggering event or condition that would cause the centralized dispatch system 105 to use them for vehicle allocation balancing. Thus, the centralized dispatch system 105 may assign vehicles from parking garages according on a cyclical basis. For example, as long as there is a predicted demand in the system for additional vehicles to be sent to boarding zones, the centralized dispatch system 105 may release vehicles on a cyclic basis, such as one vehicle every 10 seconds, one vehicle every minute, one vehicle every five minutes, or the like.

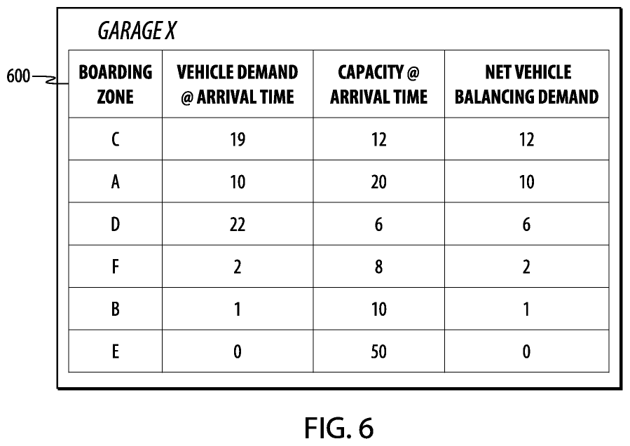

FIG. 6 illustrates how the vehicle allocation balancing process may proceed for a parking garage, such as parking garage X in FIG. 2. In particular, table 600 shows how the boarding zones are evaluated to determine a boarding zone assignment for a next vehicle in the parking garage. Notably, because the vehicles in the parking garage all have the same location (and also may all have full charges or fuel tanks), the vehicle allocation process need not consider the vehicles individually. In some cases, however, aspects that are unique to the vehicles may be considered when assigning the vehicles to boarding zones (e.g., vehicle range, battery health/age, battery capacity, fuel tank capacity, age or mileage of vehicle, etc.).

As shown in table 600, the parameters evaluated when determining where to send vehicles from parking garage X include the estimated vehicle demand at the vehicles' estimated time of arrival at that boarding zone (e.g., based on the distance between parking garage X and the respective boarding zone, traffic conditions, etc.), the respective boarding zone's capacity at the vehicles' estimated time of arrival, and the net vehicle balancing demand at the respective boarding zone. The net vehicle balancing demand for a respective boarding zone may correspond to the greater of (1) the estimated vehicle demand of the boarding zone at the vehicles' estimated time of arrival, or (2) the capacity of the boarding zone at the vehicles' estimated time of arrival. More particularly, while a boarding zone may have a high demand for vehicles, it may not be effective to send vehicles to that boarding zone if the boarding zone does not have sufficient parking or storage facilitates for those vehicles.

Once the centralized dispatch system 105 has determined the net vehicle balancing demand, it may assign a vehicle to the boarding zone with the highest net vehicle balancing demand. If there are multiple boarding zones with the same highest net vehicle balancing demand, the centralized dispatch system 105 may select one of those boarding zones at random or based on other factors (e.g., the nearest boarding zone, the historically busiest boarding zone, etc.). Returning to table 600, the centralized dispatch system 105 may assign a vehicle to boarding zone C, as it has the highest net vehicle balancing demand.

Once a vehicle is assigned to the boarding zone with the highest net vehicle balancing demand, the estimated vehicle demand value for that boarding zone may be decremented by 1, reflecting the fact that the vehicle being sent to the boarding zone will reduce the boarding zone's need by one. The decrement in the estimated vehicle demand may be accounted for by simply recalculating or otherwise updating the calculation for the estimated vehicle demand, as that calculation already accounts for the number of vehicles traveling to the boarding zone.

After assigning a vehicle to boarding zone C, the centralized dispatch system 105 may cyclically execute the vehicle allocation balancing process, assigning vehicles to the boarding zone that needs vehicles the most and has capacity to park and/or store those vehicles when they arrive. This process may continue until there are no boarding zones that are within range of the parking garage that have a net vehicle balancing demand, or the parking garage runs out of vehicles to dispatch.

Once a vehicle is assigned to a trip request (and/or a trip request is assigned to a vehicle), the vehicle may autonomously or semi-autonomously navigate to the assigned boarding zone, parking garage, or other designated location. In some cases, the transportation system controller 102 may provide a route for the vehicle to follow to get to the designated location. In some cases, the vehicle may determine, optionally using the system state monitor 103, its own route to the designated location. In some cases, the vehicle and the transportation system controller 102 cooperate to determine the route to the designated location.

The trip assignment schemes described herein may be used with or by a transportation system in which numerous vehicles may be autonomously operated to transport passengers and/or freight along a roadway. For example, a transportation system or service may provide a fleet of vehicles that operate along the roadway. Vehicles in such a transportation system may be configured to operate autonomously, such as according to one or more vehicle schemes as described herein (e.g., a platooning scheme, a moving position-target scheme, etc.). As used herein, the term “autonomous” may refer to a mode or scheme in which vehicles can operate without continuous, manual control by a human operator. For example, driverless vehicles may navigate along a roadway using a system of automatic drive and steering systems that control the speed and direction of the vehicle. In some cases, the vehicles may not require steering, speed, or directional control from the passengers, and may exclude controls such as passenger-accessible accelerator and brake pedals, steering wheels, and other manual controls. In some cases, the vehicles may include manual drive controls that may be used for maintenance, emergency overrides, or the like. Such controls may be hidden, stowed, or otherwise not directly accessible by a user during normal vehicle operation. For example, they may be designed to be accessed only by trained operators, maintenance personnel, or the like.

Autonomous operation need not exclude all human or manual operation of the vehicles or of the transportation system as a whole. For example, human operators may be able to intervene in the operation of a vehicle for safety, convenience, testing, or other purposes. Such intervention may be local to the vehicle, such as when a human driver takes controls of the vehicle, or remotely, such as when an operator sends commands to the vehicle via a remote control system. Similarly, some aspects of the vehicles may be controlled by passengers of the vehicles. For example, a passenger in a vehicle may select a target destination, a route, a speed, control the operation of the doors and/or windows, or the like. Accordingly, it will be understood that the terms “autonomous” and “autonomous operation” do not necessarily exclude all human intervention or operation of the individual vehicles or of the overall transportation system.

The vehicles in the transportation system may include various sensors, cameras, communications systems, processors, and/or other components or systems that help facilitate autonomous operation. For example, the vehicles may include a sensor array that detects magnets or other markers embedded in the roadway and which help the vehicle determine its location, position, and/or orientation on the roadway. The vehicles may also include wireless vehicle-to-vehicle communications systems, such as optical communications systems, that allow the vehicles to inform one another of operational parameters such as their braking status, the number of vehicles ahead in a platoon, acceleration status, their next maneuver (e.g., right turn, left turn, planned stop), their number or type of payload (e.g., humans or freight), or the like. The vehicles may also include wireless communications systems to facilitate communication with a transportation system controller that has supervisory command and control authority over the transportation system.

The vehicles in the transportation system may be designed to enhance the operation and convenience of the transportation system. For example, a primary purpose of the transportation system may be to provide comfortable, convenient, rapid, and efficient personal transportation. To provide personal comfort, the vehicles may be designed for easy passenger ingress and egress, and may have comfortable seating arrangements with generous legroom and headroom. The vehicles may also have a sophisticated suspension system that provides a comfortable ride and dynamically adjustable parameters to help keep the vehicle level, positioned at a convenient height, and to ensure a comfortable ride throughout a range of variable load weights.

Conventional personal automobiles are designed for operation primarily in only one direction. This is due in part to the fact that drivers are oriented forwards, and operating in reverse for long distances is generally not safe or necessary. However, in autonomous vehicles, where humans are not directly controlling the operation of the vehicle in real-time, it may be advantageous for a vehicle to be able to operate bidirectionally. For example, the vehicles in a transportation system as described herein may be substantially symmetrical, such that the vehicles lack a visually or mechanically distinct front or back. Further, the wheels may be controlled sufficiently independently so that the vehicle may operate substantially identically no matter which end of the vehicle is facing the direction of travel. This symmetrical design provides several advantages. For example, the vehicle may be able to maneuver in smaller spaces by potentially eliminating the need to make U-turns or other maneuvers to re-orient the vehicles so that they are facing “forward” before initiating a journey.

FIGS. 7A and 7B are perspective views of an example four-wheeled roadway vehicle 700 (referred to herein simply as a “vehicle”) that may be used in a transportation system as described herein. FIGS. 7A-7B illustrate the symmetry and bidirectionality of the vehicle 700. In particular, the vehicle 700 defines a first end 702, shown in the forefront in FIG. 7A, and a second end 704, shown in the forefront in FIG. 7B. In some examples and as shown, the first and second ends 702, 704 are substantially identical. Moreover, the vehicle 700 may be configured so that it can be driven with either end facing the direction of travel. For example, when the vehicle 700 is travelling in the direction indicated by arrow 714, the first end 702 is the leading end of the vehicle 700, while when the vehicle 700 is traveling in the direction indicated by arrow 712, the second end 704 is the leading end of the vehicle 700.

The ability of the vehicles to operate bidirectionally may allow the roadway systems, and in particular boarding zones, to be made more compact. For example, when a vehicle that is configured to travel primarily only in one direction (e.g., with reverse operation being provided for convenience and maneuvering, but not for continuous driving functions) pulls into a blind parking spot, it must executed a y-turn maneuver in order to exit the parking spot and begin forward travel. On the other hand, a vehicle configured to operate equally well in either direction (e.g., a bidirectional vehicle) may can simply exit the parking spot already facing the direction of travel. Accordingly, vehicles capable of bidirectional operation require less space to maneuver in boarding zones, allowing the boarding zones to be more compact and operated more efficiently. For example, a y-turn maneuver could temporarily block more adjacent parking spots than a vehicle that can simply turn directly towards its desired direction of travel, regardless of which direction that is. And while pull-through parking spots may eliminate the need to perform y-turn maneuvers in unidirectional vehicles, boarding zones with pull-through parking spots require a larger area than those with blind parking spots. Accordingly, using bidirectional vehicles, such as the vehicle 700, facilitates the use of smaller, more compact boarding zones and for more efficient operation of the boarding zones.

The vehicle 700 may also include wheels 706 (e.g., wheels 706-1-706-4). The wheels 706 may be paired according to their proximity to an end of the vehicle. Thus, wheels 706-1, 706-3 may be positioned proximate the first end 702 of the vehicle and may be referred to as a first pair of wheels 706, and the wheels 706-2, 706-4 may be positioned proximate the second end 704 of the vehicle and may be referred to as a second pair of wheels 706. Each pair of wheels may be driven by at least one motor (e.g., an electric motor), and each pair of wheels may be able to steer the vehicle. Because each pair of wheels is capable of turning to steer the vehicle, the vehicle may have similar driving and handling characteristics regardless of the direction of travel. In some cases, the vehicle may be operated in a two-wheel steering mode, in which only one pair of wheels steers the vehicle 700 at a given time. In such cases, the particular pair of wheels that steers the vehicle 700 may change when the direction of travel changes. In other cases, the vehicle may be operated in a four-wheel steering mode, in which the wheels are operated in concert to steer the vehicle. In a four-wheel steering mode, the pairs of wheels may either turn in the same direction or in opposite directions, depending on the steering maneuver being performed and/or the speed of the vehicle.

The vehicle 700 may also include doors 708, 710 that open to allow passengers and other payloads (e.g., packages, luggage, freight) to be placed inside the vehicle 700. The doors 708, 710, which are described in greater detail herein, may extend over the top of the vehicle such that they each define two opposite side segments. For example, each door defines a side segment on a first side of the vehicle and another side segment on a second, opposite side of the vehicle. The doors also each define a roof segment that extends between the side segments and defines part of the roof (or top side) of the vehicle. In some cases, the doors 708, 710 resemble an upside-down “U” in cross-section and may be referred to as canopy doors. The side segments and the roof segment of the doors may be formed as a rigid structural unit, such that all of the components of the door (e.g., the side segments and the roof segment) move in concert with one another. In some cases, the doors 708, 710 include a unitary shell or door chassis that is formed from a monolithic structure. The unitary shell or door chassis may be formed from a composite sheet or structure including, for example, fiberglass, carbon composite, and/or other lightweight composite materials.

The vehicle 700 may also include a vehicle controller that controls the operations of the vehicle 700 and the vehicle's systems and/or subsystems. For example, the vehicle controller may control the vehicle's drive system, steering system, suspension system, doors, and the like, to facilitate vehicle operation, including to navigate the vehicle along a roadway in accordance with one or more vehicle control schemes. The vehicle controller may also be configured to communicate with other vehicles, the transportation system controller, vehicle presence detectors, or other components of the transportation system. For example, the vehicle controller may be configured to receive information from other vehicles about those vehicles' position in a platoon, speed, upcoming speed or direction changes, or the like. The vehicle controller may also be configured to receive information from vehicle presence detectors about available vehicle positions. The vehicle controller may include computers, processors, memory, circuitry, or any other suitable hardware components, and may be interconnected with other systems of the vehicle to facilitate the operations described herein, as well as other vehicle operations.

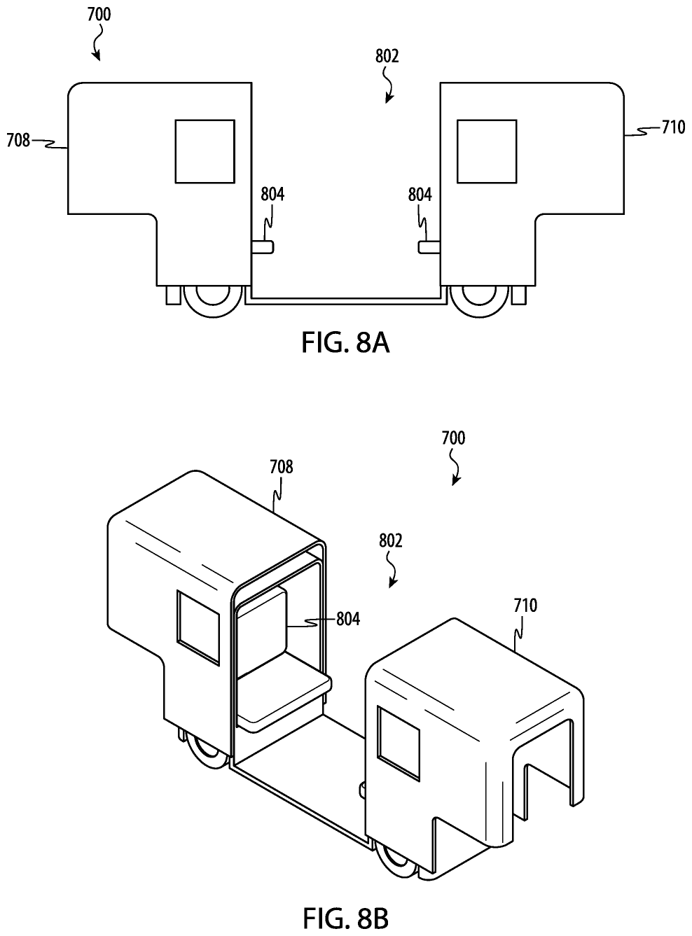

FIGS. 8A and 8B are side and perspective views of the vehicle 700 with the doors 708, 710 in an open state. Because the doors 708, 710 each define two opposite side segments and a roof segment, an uninterrupted internal space 802 may be revealed when the doors 708, 710 are opened. In the example depicted in FIGS. 8A and 8B, when the doors 708, 710 are opened, an open section may be defined between the doors 708, 710 that extends from one side of the vehicle 700 to the other. This may allow for unimpeded ingress and egress into the vehicle 700 by passengers on either side of the vehicle 700. The lack of an overhead structure when the doors 708, 710 are opened may allow passengers to walk across the vehicle 700 without a limit on the overhead clearance.

The vehicle 700 may also include seats 804, which may be positioned at opposite ends of the vehicle 700 and may be facing one another. As shown, the vehicle includes two seats 804, though other numbers of seats and other arrangements of seats are also possible (e.g., zero seats, one seat, three seats, etc.). In some cases, the seats 804 may be removed, collapsed, or stowed so that wheelchairs, strollers, bicycles, or luggage may be more easily placed in the vehicle 700.

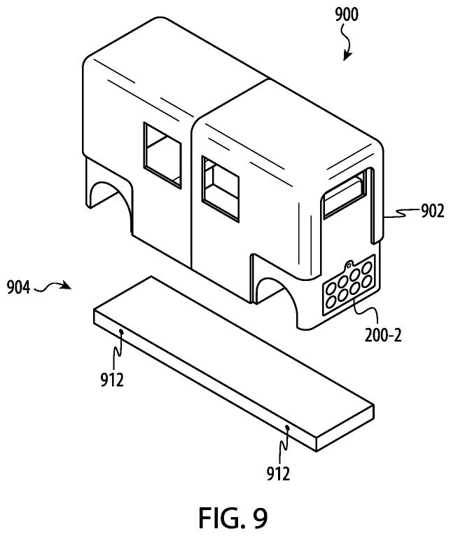

Vehicles for use in a transportation system as described herein, such as the vehicle 700, may be designed for safe and comfortable operation, as well as for ease of manufacture and maintenance. To achieve these advantages, the vehicles may be designed to have a frame structure that includes many of the structural and operational components of the vehicle (e.g., the motor, suspension, batteries, etc.) and that is positioned low to the ground. A body structure may be attached or secured to the frame structure. FIG. 9 illustrates a partial exploded view of a vehicle, which may be an embodiment of the vehicle 700, showing an example configuration of a frame structure and body structure. As described below, the low position of the frame structure combined with the relatively lightweight body structure produces a vehicle with a very low center of gravity, which increases the safety and handling of the vehicle. For example, a low center of gravity reduces the rollover risk of the vehicle when the vehicle encounters slanted road surfaces, wind loading, sharp turns, or the like, and also reduces body roll of the vehicle during turning or other maneuvers. Further, by positioning many of the operational components of the vehicle, such as motors, batteries, a vehicle controller, sensors (e.g., sensors that detect road-mounted magnets or other markers), and the like, on the frame structure (e.g., the frame structure 904, FIG. 9), manufacture and repair may be simplified.

FIG. 9 is a partial exploded view of a vehicle 900, which may be an embodiment of the vehicle 700. Details of the vehicle 700 may be equally applicable to the vehicle 900, and will not be repeated here. The vehicle 900 may include a body structure 902, which may include doors (e.g., the doors 708, 710, described above) and other body components, and a frame structure 904 to which the body structure 902 is attached.

The frame structure 904 may include drive, suspension, and steering components of the vehicle. For example, the frame structure 904 may include wheel suspension systems (which may define or include wheel mounts, axles, or hubs, represented in FIG. 9 as points 912), steering systems, drive motors, and optionally motor controllers. Wheels may be mounted to the wheel suspension systems via the wheel mounts, axles, hubs, or the like. The drive motors may include one or more drive motors that drive the wheels, either independently or in concert with one another. The drive motors may receive power from a power source (e.g., battery) that is mounted on the frame structure 904. Motor controllers for the drive motors may also be mounted on the frame structure 904.

The suspension systems may be any suitable type of suspension system. In some cases, the suspension systems include independent suspension systems for each wheel. For example, the suspension systems may be double-wishbone torsion-bar suspension systems. The suspension systems may also be dynamically adjustable, such as to control the ride height, suspension preload, damping, or other suspension parameters while the vehicle is stationary or while it is moving. Other suspension systems are also contemplated, such as swing axle suspension, sliding pillar suspension, MacPherson strut suspension, or the like. Moreover, spring and damping functions may be provided by any suitable component or system, such as coil springs, leaf springs, pneumatic springs, hydropneumatic springs, magneto-rheological shock absorbers, and the like. The suspension systems may be configured to operate in conjunction with the contour of a road surface (e.g., of a roadway as described above) to maintain a desired experience for a passenger.

The frame structure 904 may also include steering systems that allow the wheels to be turned to steer the vehicle. In some cases the wheels may be independently steerable, or they may be linked (e.g., via a steering rack) so that they always point in substantially the same direction during normal operation of the vehicle. Further, this allows the vehicles to use four-wheel steering schemes, as well as to alternate between two-wheel steering and four-wheel steering schemes.

The frame structure 904 may include components such as batteries, motors, and mechanisms for opening and closing the vehicle's doors, control systems (including computers or other processing units), and the like.

FIG. 9 illustrates example configurations of vehicles and frame structures. Other configurations are also possible, however. Moreover, the frame structure and the body structure shown in FIG. 9 are intended more as schematic representations of these components, and these components may include other structures that are omitted from FIG. 9 for clarity. Additional structural connections and integrations may be made between the body structure and the frame structure than are explicitly represented in FIG. 9. For example, components of a door mechanism that open and close the doors of the body structures may be joined to both the doors and to the frame structure.

FIG. 10 illustrates a sample electrical block diagram of an electronic device 1000 that may perform the operations described herein. The electronic device 1000 may in some cases take the form of any of the electronic devices (or provide services associated with the systems) described herein, including the transportation system controller 102, the system state monitor 103, the centralized dispatch system 105, or other computing devices or systems described herein. The electronic device 1000 can include one or more of a display 1012, a processing unit 1002, a power source 1014, a memory 1004 or storage device, input devices 1006, and output devices 1010. In some cases, various implementations of the electronic device 1000 may lack some or all of these components and/or include additional or alternative components.

The processing unit 1002 can control some or all of the operations of the electronic device 1000. The processing unit 1002 can communicate, either directly or indirectly, with some or all of the components of the electronic device 1000. For example, a system bus or other communication mechanism 1016 can provide communication between the processing unit 1002, the power source 1014, the memory 1004, the input device(s) 1006, and the output device(s) 1010.

The processing unit 1002 can be implemented as any electronic device capable of processing, receiving, or transmitting data or instructions. For example, the processing unit 1002 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1000 can be controlled by multiple processing units. For example, select components of the electronic device 1000 (e.g., an input device 1006) may be controlled by a first processing unit and other components of the electronic device 1000 (e.g., the display 1012) may be controlled by a second processing unit, where the first and second processing units may or may not be in communication with each other.

The power source 1014 can be implemented with any device capable of providing energy to the electronic device 1000. For example, the power source 1014 may be one or more batteries or rechargeable batteries. Additionally or alternatively, the power source 1014 can be a power connector or power cord that connects the electronic device 1000 to another power source, such as a wall outlet.

The memory 1004 can store electronic data that can be used by the electronic device 1000. For example, the memory 1004 can store electronic data or content such as, for example, trip requests, user information, historical usage data, maps and/or layouts of the transportation system, vehicle data (e.g., information about each vehicle in the system, including assignment status, remaining charge, maintenance history, etc.), or the like. The memory 1004 can be configured as any type of memory. By way of example only, the memory 1004 can be implemented as random access memory, read-only memory, Flash memory, removable memory, other types of storage elements, or combinations of such devices.

In various embodiments, the display 1012 provides a graphical output, for example associated with an operating system, user interface, and/or applications of the electronic device 1000. In one embodiment, the display 1012 includes one or more sensors and is configured as a touch-sensitive (e.g., single-touch, multi-touch) and/or force-sensitive display to receive inputs from a user. For example, the display 1012 may be integrated with a touch sensor (e.g., a capacitive touch sensor) and/or a force sensor to provide a touch- and/or force-sensitive display. The display 1012 is operably coupled to the processing unit 1002 of the electronic device 1000.

The display 1012 can be implemented with any suitable technology, including, but not limited to liquid crystal display (LCD) technology, light emitting diode (LED) technology, organic light-emitting display (OLED) technology, organic electroluminescence (OEL) technology, or another type of display technology. In some cases, the display 1012 is positioned beneath and viewable through a cover that forms at least a portion of an enclosure of the electronic device 1000.

In various embodiments, the input devices 1006 may include any suitable components for detecting inputs. Examples of input devices 1006 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1006 may be configured to detect one or more particular types of input and provide a signal (e.g., an input signal) corresponding to the detected input. The signal may be provided, for example, to the processing unit 1002.

The output devices 1010 may include any suitable components for providing outputs. Examples of output devices 1010 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 1010 may be configured to receive one or more signals (e.g., an output signal provided by the processing unit 1002) and provide an output corresponding to the signal.

In some cases, input devices 1006 and output devices 1010 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1002 may be operably coupled to the input devices 1006 and the output devices 1010. The processing unit 1002 may be adapted to exchange signals with the input devices 1006 and the output devices 1010. For example, the processing unit 1002 may receive an input signal from an input device 1006 that corresponds to an input detected by the input device 1006. The processing unit 1002 may interpret the received input signal to determine whether to provide and/or change one or more outputs in response to the input signal. The processing unit 1002 may then send an output signal to one or more of the output devices 1010, to provide and/or change outputs as appropriate.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. For example, while the methods or processes disclosed herein have been described and shown with reference to particular operations performed in a particular order, these operations may be combined, sub-divided, or re-ordered to form equivalent methods or processes without departing from the teachings of the present disclosure. Moreover, structures, features, components, materials, steps, processes, or the like, that are described herein with respect to one embodiment may be omitted from that embodiment or incorporated into other embodiments. Further, while the term “roadway” is used herein to refer to structures that support moving vehicles, the roadway described herein does not necessarily conform to any definition, standard, or requirement that may be associated with the term “roadway,” such as may be used in laws, regulations, transportation codes, or the like. As such, the roadway described herein is not necessarily required to (and indeed may not) provide the same features and/or structures of a conventional “roadway.” Of course, the roadways described herein may comply with any and all applicable laws, safety regulations, or other rules for the safety of passengers, bystanders, operators, builders, maintenance personnel, or the like.

What is claimed is:

1. A method of assigning a vehicle to a trip request in a transportation system comprising a plurality of vehicles configured to autonomously navigate along a roadway, comprising:
receiving, at a dispatch server system of the transportation system, a trip request comprising:
an origin location;
a destination location; and
a requested vehicle arrival time;
identifying a subset of vehicles from the plurality of vehicles, each respective vehicle in the identified subset of vehicles:
having sufficient energy to travel from the origin location to the destination location; and
having a respective estimated time of arrival at the origin location corresponding to a time at which the origin location is predicted to have available boarding capacity;
choosing, from the subset of vehicles, a selected vehicle having an earliest estimated time of arrival at the origin location;
assigning the selected vehicle to the trip request; and
sending information about the trip request to the selected vehicle.

2. The method of claim 1, wherein each respective vehicle in the identified subset of vehicles is, at the time the subset is identified, travelling to the origin location.

3. The method of claim 1, wherein each respective estimated time of arrival of the vehicles in the identified subset of vehicles is within a threshold time after the requested vehicle arrival time.

4. The method 1, wherein:
the origin location corresponds to a first boarding zone having a first fixed location within the transportation system; and
the destination location corresponds to a second boarding zone having a second fixed location within the transportation system.

5. The method of claim 1, wherein the trip request is received from a mobile phone.

6. The method of claim 5, further comprising sending, to the mobile phone, an identifier of the selected vehicle.

7. The method of claim 1, wherein each respective vehicle in the identified subset of vehicles has sufficient energy to travel from the destination location to a charging station after termination of a trip associated with the trip request.

8. A method of assigning a vehicle to a trip request in a transportation system comprising a plurality of vehicles configured to autonomously navigate along a roadway, comprising:
receiving, at a dispatch server system of the transportation system, a trip request comprising:
an origin location;
a destination location; and
a requested vehicle arrival time;
identifying, from the plurality of vehicles, a first subset of candidate vehicles in which each vehicle is travelling to the origin location and has an estimated time of arrival at the origin location within a threshold time after the requested vehicle arrival time;
identifying, from the first subset of candidate vehicles, a second subset of candidate vehicles that have sufficient energy to reach the destination location from the origin location;
choosing, from the second subset of candidate vehicles, a selected vehicle having an earliest estimated time of arrival at the origin location;
assigning the selected vehicle to the trip request; and
sending information about the trip request to the selected vehicle.

9. The method of claim 8, wherein:
the dispatch server system maintains a list of pending trip requests that have not been assigned a vehicle; and
the trip request is an oldest trip request in the list of pending trip requests that have not been assigned a vehicle.

10. The method of claim 8, wherein the threshold time is less than or equal to ten minutes after the requested vehicle arrival time.

11. The method of claim 8, further comprising, after assigning the selected vehicle to the trip request and prior to the selected vehicle arriving at the origin location:
identifying an additional vehicle having an earlier estimated time of arrival at the origin location than the selected vehicle;
cancelling the assignment of the selected vehicle to the trip request; and
assigning the additional vehicle to the trip request.

12. The method of claim 8, wherein each respective vehicle in the second subset of vehicles has sufficient energy to travel from the destination location to a charging station after termination of a trip associated with the trip request.

13. A method of assigning a vehicle to a target location in a transportation system comprising a plurality of vehicles configured to autonomously navigate along a roadway, comprising:
at a dispatch server system of the transportation system:
identifying a vehicle to be assigned a target location;
identifying a subset of boarding zones from a plurality of boarding zones in the transportation system, each respective boarding zone in the identified subset of boarding zones:
having available vehicle storage capacity at an estimated time of arrival of the vehicle at the respective boarding zone;
reachable by the vehicle based on the vehicle's current location and current energy state; and
associated with a respective estimated vehicle demand;
choosing, from the subset of boarding zones, a selected boarding zone having a highest estimated vehicle demand;
assigning the selected boarding zone as the target location of the vehicle; and
sending, to the vehicle, information about the target location, thereby causing the vehicle to begin travelling to the selected boarding zone.

14. The method of claim 13, further comprising determining, for each respective boarding zone of the subset of boarding zones, a respective estimated vehicle demand at the estimated time of arrival of the vehicle at the respective boarding zone.

15. The method of claim 14, wherein the estimated vehicle demand for each respective boarding zone is based at least in part on:
a historical number of trips departing from the respective boarding zone;
a number of vehicles travelling to the respective boarding zone and estimated to arrive at the respective boarding zone within a particular time window; and
a number of trips scheduled to depart from the respective boarding zone and for which vehicle have not been assigned.

16. The method of claim 15, wherein the estimated vehicle demand for each respective boarding zone is further based at least in part on a weather forecast at the respective boarding zone.

17. The method of claim 15, wherein the estimated vehicle demand for each respective boarding zone is further based at least in part on an end time of an event proximate the respective boarding zone.

18. The method of claim 15, wherein the particular time window is a time prior to the estimated time of arrival of the vehicle.

19. The method of claim 13, further comprising, after assigning the selected boarding zone as the target location of the vehicle, decrementing the estimated vehicle demand of the selected boarding zone by one vehicle.

20. The method of claim 13, wherein the vehicle is parked at a charging station when it is identified.
